(19) United States
(12) Patent Application Publication
(10) Pub. No.: US 2026/0064739 A1
(43) Pub. Date: Mar. 5, 2026

(54) LARGE LANGUAGE MODEL ARCHITECTURE FOR DELIVERING DIGITAL CONTENT

(71) Applicant: ADP, Inc., Roseland, NJ (US)

(72) Inventors: Katsutoshi Fukuoka, Porto Alegre (BR); Rafael Cirolini, Roseland, NJ (US); Carlos Nascimento, Porto Alegre (BR); Willian Lemos, Porto Alegre (BR); Bruno Davila, Porto Alegre (BR); Jhole Bagnasco, Roseland, NJ (US); Kim Agliardi, Roseland, NJ (US)

(73) Assignee: ADP, Inc., Roseland, NJ (US)

(21) Appl. No.: 18/819,347

(22) Filed: Aug. 29, 2024

(51) Int. Cl. G06F 16/33; G06F 16/34

(52) U.S. Cl. CPC G06F 16/3344; G06F 16/345

(57) ABSTRACT

Large language model architecture for delivering digital content is provided. A system can receive a query indicating a request for document objects, and criteria for selection of the document objects. The system obtains first data objects each having a first structure in a first format identifying portions of the one or more document objects. The first data objects can be searchable according to the one or more criteria via the first structure. The system provides input to a large language model (LLM) including the query, the first data objects, and second data objects. The second data objects can have a second structure in a second format that is compatible with the LLM. The system generates a reply to the query identifying a set of the one or more document objects that satisfies the one or more criteria for selection.

### TECHNICAL FIELD

This application is generally related to computing technology, and, more particularly, to a large language model architecture for delivering digital content.

### BACKGROUND

A computing system can include a user interface, which can be used to instruct the computing system to perform various actions. Due to the large number of actions that can be performed by a computing system, it can be challenging or error prone to efficiently and reliably interact with a user interface of the computing system to search for a particular action, or instruct the computing system to perform such action, thereby introducing delays, latency, or utilizing unnecessary computing resources when incorrect actions are selected or performed by the computing system.

### SUMMARY

Aspects of technical solutions described herein are directed to a computing architecture and, more particularly, a large language model architecture for delivering digital content. For example, aspects of the technical solution can use natural language processing models, such as conversational or chat-based models, that can be configured to deliver digital content. Due to the increasingly nuanced contexts and requests received by computing systems, it can be technically challenging for a system to accurately and reliably interpret such requests and the associated context, let alone efficiently respond to such requests without utilizing excessive computation resources or latency, especially in large or complex data sets. Aspects of the technical solutions can manage diverse data formats and structures within a unified framework while scaling to manage large datasets. For example, the system's adaptability to evolving data characteristics and user needs can ensure the delivery of consistent and relevant results. The technical solutions can implement dynamic algorithms capable of accurately interpreting and responding to data queries. For example, the system can capture the specific nuances desired for precise data interpretation. By bridging the semantic gap between user queries and underlying data representations, the system can fully process and interpret the context and meaning behind user queries. For instance, in the job search domain, the system can accurately address the specific requirements of job positions by focusing on understanding syntax and sentence structure rather than relying solely on keyword matching. This approach can prevent irrelevant job suggestions and improve the delivery of digital content.

The computing architecture of the technical solutions described herein can provide a flexible computational approach configured to adapt to individual contexts and customized requests via multiple models tailored to various aspects of the workflow. Additionally, by leveraging a natural language model, the system can generate improved interactive user interfaces that can facilitate dynamically refining search criteria based on real-time input or feedback. The computing architecture can be applied across various domains through, for example, a chat interface. The architecture can use a plurality of models trained with machine learning to process inputs and deliver accurate data responses. The technical solutions can implement a unique blend of information retrieval, named entity recognition, and a generative chat model that ensures dynamic, context-sensitive, and accurate processing of user interactions. For example, a system according to this disclosure can process and manage user-submitted data to address specific needs, where the data is structured according to predefined criteria and further defined by additional descriptive data.

A technical solution according to this disclosure is directed to an architecture driven by artificial intelligence (e.g., machine learning) that combines multiple elements for delivering nuanced digital content. The technical solutions described herein can be enhanced by integrating natural language processing (NLP) techniques or a natural language AI pipeline, which can facilitate the processing of syntax in text data to provide a more intuitive, personalized, and adaptive digital content delivery system. These NLP models, such as the large language models, can be trained on datasets of textual content, such as job postings and descriptions. This training can allow the NLP models to identify patterns and elements that are phrased within the text. The NLP models can be used not only to process existing text data but also to deliver digital content through interactive, natural language-based interactions.

The NLP models can process the syntax and sentence structure of user inputs or queries and deliver personalized job recommendations that accurately reflect the desired attributes and characteristics. The NLP models can facilitate conversational interactions by extracting key entities, such as skills, interests, and location, and can semantically process user inputs to understand context and nuances for relevant suggestions. The NLP models can deliver customized digital content recommendations that highlight particular elements or aspects most relevant to the user's input. The AI's dialogue system can adapt based on user responses, providing engagement and relevance, while an investigative AI approach can actively probe for deeper insights into user preferences. Further, entity recognition and mapping can identify and map user attributes against content criteria. The NLP models can be configured to communicate content characteristics and align them with user interests and preferences.

By incorporating advanced syntax understanding, the technical solutions described herein can maintain a deeper level of accuracy in delivering relevant digital content. This improved understanding of text can lead to more accurate identification of key elements, such as relevant skills. Leveraging conversational interactions, the NLP models can maintain a contextual understanding and use interaction (chat) history for improved recommendations. Additionally, the ongoing analysis of user interactions can help the NLP models deliver more accurate content over time. Thus, technical solutions for delivering personalized digital content are provided.

At least one aspect is directed to a system. The system can include one or more processors, coupled with memory. The system can receive a query indicating a request for one or more document objects and can include one or more criteria for selection of the one or more document objects. The system can obtain one or more first data objects each having a first structure in a first format identifying portions of the one or more document objects, the first data objects searchable according to the one or more criteria via the first structure. The system can provide input to a large language model (LLM) including the query, the first data objects, and one or more second data objects, the second data objects each having a second structure in a second format that is compatible with the LLM. The system can generate, by the LLM according to the input, a reply to the query identifying a set of the one or more document objects that satisfies the one or more criteria for selection.

The system can generate, by the LLM according to a second input including the one or more document objects and one or more third data objects, one or more summary objects. Each summary object can, respectively, include object text descriptive of each of the document objects. The system can modify the one or more first data objects to include the object text for respective instances of the one or more document objects. The object text can be descriptive of at least one of a job description or one or more skills corresponding to the job description. The third data objects can have the second structure in the machine-readable format that is compatible with the LLM. The system can generate the second data objects based on the first data objects to indicate common data according to a first format of the first structure and a second format of the second structure. The first format can correspond to a text-based format, and the second format can correspond to a machine-readable format. The second structure can correspond to at least one of an embedding compatible with the LLM or a vector compatible with the LLM. The system can determine, by the LLM according to the input, a natural language corresponding to content of the query. The system can modify, by the LLM according to the input, at least one portion of at least one of the documents to the natural language. The system can determine the natural language according to a plurality of queries including the query. The plurality of queries can correspond to a chat history of a plurality of inputs for the LLM.

At least one aspect is directed to a method. The method can include receiving a query indicating a request for one or more document objects and can include one or more criteria for selection of the one or more document objects. The method can include obtaining one or more first data objects each having a first structure in a first format identifying portions of the one or more document objects, the first data objects searchable according to the one or more criteria via the first structure. The method can include providing input to a large language model (LLM) including the query, the first data objects, and one or more second data objects, the second data objects each having a second structure in a second format that is compatible with the LLM. The method can include generating, by the LLM according to the input, a reply to the query identifying a set of the one or more document objects that satisfies the one or more criteria for selection.

The method can include generating, by the LLM according to a second input including the one or more document objects and one or more third data objects, one or more summary objects. Each summary object can, respectively, include object text descriptive of each of the document objects. The method can include modifying the one or more first data objects to include the object text for respective instances of the one or more document objects. The object text can be descriptive of at least one of a job description or one or more skills corresponding to the job description. The third data objects can have the second structure in the machine-readable format that is compatible with the LLM. The method can include generating the second data objects based on the first data objects to indicate common data according to a first format of the first structure and a second format of the second structure. The first format can correspond to a text-based format, and the second format can correspond to a machine-readable format. The second structure can correspond to at least one of an embedding compatible with the LLM or a vector compatible with the LLM. The method can include determining, by the LLM according to the input, a natural language corresponding to content of the query. The method can include modifying, by the LLM according to the input, at least one portion of at least one of the documents to the natural language. The method can include determining the natural language according to a plurality of queries including the query. The plurality of queries can correspond to a chat history of a plurality of inputs for the LLM.

At least one aspect is directed to a non-transitory computer readable medium including one or more instructions stored thereon and executable by a processor. The processor can receive a query indicating a request for one or more document objects and can include one or more criteria for selection of the one or more document objects. The processor can obtain one or more first data objects each having a first structure in a first format identifying portions of the one or more document objects, the first data objects searchable according to the one or more criteria via the first structure. The processor can provide input to a large language model (LLM) including the query, the first data objects, and one or more second data objects, the second data objects each having a second structure in a second format that is compatible with the LLM. The processor can generate, executing the LLM according to the input, a reply to the query identifying a set of the one or more document objects that satisfies the one or more criteria for selection.

The processor can generate, executing the LLM according to a second input including the one or more document objects and one or more third data objects, one or more summary objects. Each summary object can, respectively, include object text descriptive of each of the document objects. The processor can modify the one or more first data objects to include the object text for respective instances of the one or more document objects. The object text can be descriptive of at least one of a job description or one or more skills corresponding to the job description.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, according to this disclosure.

FIG. 2 depicts an example computer execution architecture, according to this disclosure.

FIG. 3 depicts an example computer execution workflow, according to this disclosure.

FIG. 4 depicts an example method of large language model architecture for delivering digital content, according to this disclosure.

FIG. 5 depicts an example method of large language model architecture for delivering digital content, according to this disclosure.

FIG. 6 depicts a block diagram of an example computing system for implementing the embodiments of the present solution, including, for example, the system depicted in FIG. 1, and the methods depicted in FIGS. 4-5.

### DETAILED DESCRIPTION

Aspects of the technical solutions described herein with reference to the figures, which are illustrative examples of this technical solution. The figures and examples below are not meant to limit the scope of the technical solutions to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

Aspects of the technical solutions achieve digital content delivery across various domains, via an architecture employing a suite of advanced machine learning technologies in a conversational interface. For example, the technical solutions can use a system architecture that can process user queries to identify relevant documents. The system can receive queries specifying document requests and associated selection criteria. To fulfill these requests, the system can access and process structured data collections, including document information. The document information can be formatted to allow efficient searching and retrieval based on query parameters. By incorporating a large language model (LLM), the system can enhance query understanding, refine search criteria, and generate responses that accurately reflect the user's intent.

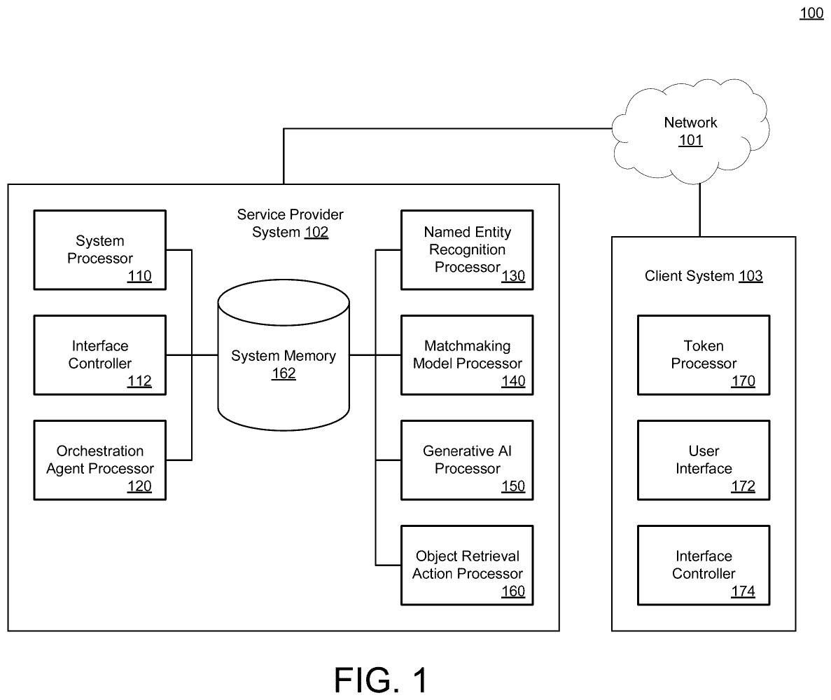

FIG. 1 depicts an example system, according to this disclosure. As illustrated by way of example in FIG. 1, a system 100 can include at least a network 101, a service provider system 102, and a client system 103. In an aspect, the system 100 according to an architecture as discussed herein encompasses four distinct machine learning models, each serving a unique purpose in the digital content delivery process. The system 100 can provide a combination of information/object retrieval, named entity recognition, a suite of machine learning models, and a conversational interface as a powerful tool for various applications, especially in scenarios requiring nuanced understanding and contextual adaptability.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The service provider system 102 can include a physical computer system operatively coupled or coupleable with one or more components of the system 100. The service provider system 102 can include a virtual computing system, an operating system, and a communication bus to effect communication and processing. The service provider system 102 can include a system processor 110, an interface controller 112, an orchestration agent processor 120, a named entity recognition processor 130, a matchmaking model processor 140, a generative artificial intelligence processor 150, an object retrieval action processor 160, and a system memory 162.

The system processor 110 can execute one or more instructions associated with the service provider system 102. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store one or more instructions for operating components of the system processor 110 and operating components operably coupled to the system processor 110. For example, the one or more instructions can include one or more of firmware, software, hardware, operating systems, embedded operating systems. The system processor 110 or the service provider system 102 generally can include one or more communication bus controllers to effect communication between the system processor 110 and the other elements of the service provider system 102.

The interface controller 112 can link the service provider system 102 with one or more of the network 101 and the client system 103, by one or more communication interfaces. A communication interface can include, for example, an application programming interface (“API”) compatible with a particular component of the service provider system 102, or the client system 103. The communication interface can provide a particular communication protocol compatible with a particular component of the service provider system 102 and a particular component of the client system 103. The interface controller 112 can be compatible with particular content objects and can be compatible with particular content delivery systems corresponding to particular content objects, structures of data, types of data, or any combination thereof. For example, the interface controller 112 can be compatible with transmission of text data or binary data structured according to one or more metrics or data of the client system 103.

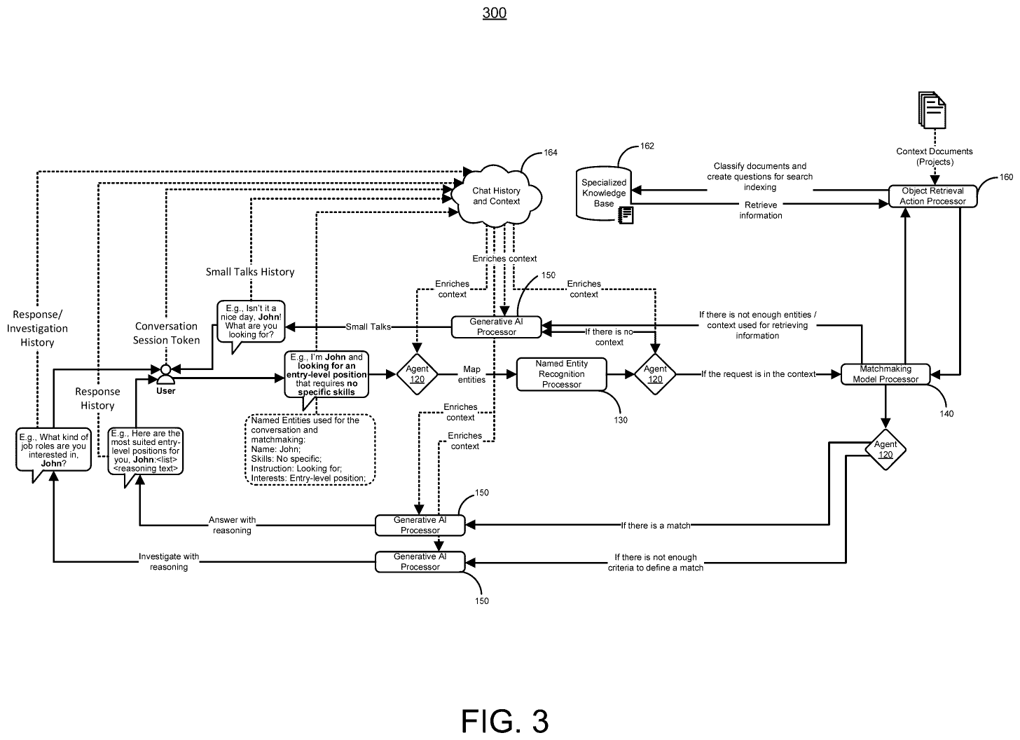

The orchestration agent processor 120 can oversee one or more of the named entity recognition processor 130, the matchmaking model processor 140, the generative artificial intelligence processor 150, and the object retrieval action processor 160, selecting the most appropriate one based on the conversation's context. For example, the orchestration agent processor 120 can interact with the named entity recognition processor 130, the matchmaking model processor 140, the generative artificial intelligence processor 150, and the object retrieval action processor 160 at one or more points in a workflow. For example, the workflow can correspond to the computer execution architecture of FIG. 3, but is not limited thereto.

One or more of the orchestration agent processor 120, the named entity recognition processor 130, the matchmaking model processor 140, the generative artificial intelligence processor 150, or the object retrieval action processor 160 can include or utilize one or more models trained with machine learning. The orchestration agent processor 120, the named entity recognition processor 130, the matchmaking model processor 140, the generative artificial intelligence processor 150, or the object retrieval action processor 160 can use the same or different models trained with machine learning. For example, the models can be trained with same or different types of machine learning techniques, trained with the same or different types of training data, or be trained or configured to receive different types of input or provide different types of output. Example machine learning techniques can include neural networks, such as a generative adversarial network (e.g., a generator neural network and a discriminator neural network that are trained simultaneously through adversarial training), a variational autoencoder (e.g., an autoencoder neural network that learns to generate new data samples by modeling the underlying probability distribution of the data), an autoregressive model, or other types of neural networks (e.g., deep learning models, convolution neural networks, recurrent neural networks, or transformers). Transformers can refer to or include a type of deep learning model architecture configured for natural language processing, including, for example, bidirectional encoder representations (“BERT”), generative pre-trained transformers, text-to-text transformer, transformer-XL, robustly optimized BERT, or distilled BERT. Other types of machine learning techniques can include supervised learning models, unsupervised learning models, semi-supervised learning models, or reinforcement learning models. For example, a supervised machine learning technique can include a support vector machine used for classification and regression tasks. Given a set of labeled training data, a support vector machine can identify the hyperplane that separates the data into classes with the largest possible margin (e.g., distance between the hyperplane and nearest data points from each class).

In an aspect, the orchestration agent processor 120 can act as a decision-maker, ensuring that the conversation flows smoothly and relevantly. For example, the orchestration agent processor 120 can include one or more interfaces to detect input at various portions of a workflow (e.g., the example workflow of FIG. 3), and can provide output responsive to specific portions of a workflow. The orchestration agent processor 120 can receive input from one or more of the interface controller 112, the named entity recognition processor 130, the matchmaking model processor 140, the generative artificial intelligence processor 150, or the object retrieval action processor 160, can determine a level of context, can enrich a level of context, and can control at least one of the interface controller 112, the named entity recognition processor 130, the matchmaking model processor 140, the generative artificial intelligence processor 150, or the object retrieval action processor 160 to take one or more actions according to a query having context that satisfies a context threshold of the orchestration agent processor 120.

For example, the orchestration agent processor 120 can obtain a query via the interface controller 112 indicative of user input, can determine whether the query has sufficient context, can augment the query with additional context if the context is not sufficient, and can provide the query with sufficient context to one or more of the interface controller 112, the named entity recognition processor 130, the matchmaking model processor 140, the generative artificial intelligence processor 150, or the object retrieval action processor 160 according to, but not limited to, the workflow of FIG. 3. As discussed herein, sufficient context corresponds to a context that satisfies a given threshold with respect to a number of data elements that can be associated with the query. For example, a threshold can correspond to five data elements, and a query associated with at least five data elements can be considered to have sufficient context. For example, additional context, as discussed herein, can correspond to at least one data element. The data element can include, but is not limited to, information associated with the content of a query. For example, a query can include a job title or role, and a data element corresponding to additional context can include required skills, desired location, salary expectations, or a telephone number for the relevant person or business.

The named entity recognition processor 130 can identify and categorize named entities within the conversation, aiding in understanding the context and refining the digital content delivery or personalized job recommendation process. In an aspect, the named entity recognition processor 130 can include a natural language processor that can receive input corresponding to text, image, or video data, and can generate one or more text objects corresponding to the text, image or video data. The natural language processor can include indicators (e.g., tokens) that can identify a given portion of a query as indicative of a named entity or not indicative of a named entity. For example, a named entity can correspond to a proper noun identifying a skill, job title, location, or company, but is not limited thereto.

In an aspect, the system has an ability to assess the suitability of potential matches based on a configurable percentage of criteria alignment. As discussed herein, a suitability of a match can be indicative of a semantic relationship between one or more of a query, a context of the query, and a response to the query. For example, a semantic relationship can indicate a correspondence between a domain of a query and a domain of a response to the query (e.g., a job recommendation), but is not limited thereto. This flexibility allows the system to be tailored to specific scenarios, enhancing its applicability across various domains. In an aspect, a percentage of criteria alignment can correspond to a threshold indicative of a percentage of terms (e.g., portions of a query) that are associated with a given object (e.g., a given job-related entity). For example, the named entity recognition processor 130 can determine, according to a natural language processor, that one or more portions of a query (e.g., one or more words or alphanumeric strings) are semantically associated with a given job-related entity. For example, the named entity recognition processor 130 can determine from a query of “what are data scientists jobs in Boston?” that the portions “data scientist” and “Boston” are associated with the job-related entities “job title” and “location.” In an aspect, the named entity recognition processor 130 can determine a threshold percentage of terms that are associated with the job-related entity, a threshold number of terms that are associated with the job-related entity, or a combination thereof, to indicate that the query has sufficient context as discussed herein. For example, the named entity recognition processor 130 can determine an alignment threshold of at least 80% of terms being associated with at least one job-related entity to determine that a query has sufficient context for job recommendation. The named entity recognition processor 130 can provide a plurality of alignment thresholds each corresponding to a given job domain, to provide a technical improvement to support contextual understanding and augmentation across a broad variety of job search scenarios that have varying complexities in search traversal or database retrieval.

The matchmaking model processor 140 can identify job listings (e.g., documents) that correspond to or are semantically related to a query. For example, the matchmaking model processor 140 can incorporate an investigative approach to identify job listings that includes semantic similarity searches. In a semantic similarity search, the system interprets and identifies context beyond literal keyword matches. For example, the configuration can go beyond literal keyword matches to understand the nuances of job seeker needs and job requirements. This capability allows the matchmaking model processor 140 to understand and respond to complex user requests with a high degree of accuracy. In an aspect, the matchmaking model processor 140 can obtain one or more tokens associated with a query according to a natural language processor as discussed herein. For example, the matchmaking model processor 140 can generate one or more tokens associated with a query according to a natural language processor as discussed herein. In an aspect, the matchmaking model processor 140 can obtain one or more tokens associated with one or more job listings according to a natural language processor as discussed herein. For example, the matchmaking model processor 140 can generate one or more tokens associated with a query according to a natural language processor as discussed herein. For example, the matchmaking model processor 140 can perform a search of one or more tokens of the query against one or more tokens of one or more job listings to match the job listings to the query. By the technical solution of token-based searching and matching, the matchmaking model processor 140 can provide a technical improvement at least to perform a semantic similarity search returning responses or job recommendations having higher accuracy and relevance.

The generative artificial intelligence processor 150 can generate output indicative of a reasoning for selection of recommended job listings, and can generate further queries to the user to obtain information that can be used to identify a more suitable job listing. For example, the generative artificial intelligence processor 150 can come into play when there is no immediate match, engaging in small talk to further investigate and understand the needs of the user, and to thus generate or obtain data indicative of context of the query. Once a suitable job listing is identified, the generative model provides reasoned responses, explaining why a particular match or job listing is suitable. In an aspect, the generative artificial intelligence processor 150 can include a generative artificial intelligence model, or can include one or more interfaces according to the interface controller 112 to perform bidirectional communication with a generative artificial intelligence external to the system 100. The conversational interface of the generative artificial intelligence processor 150 can employ a generative model for reasoning, allowing for dynamic and context-aware interactions. This model enables the service provider system 102 to not only respond to user inputs but also to evolve the conversation based on those inputs. The conversational interface can constantly update the context history, feeding this information back into the system for refined decision-making. This iterative process ensures that the job recommendation is not only based on static criteria but also evolves as the conversation progresses, achieving a technical improvement in responsiveness and accuracy beyond the capability of manual processes to achieve.

The object retrieval action processor 160 can return documents (e.g., job listings), and can provide information corresponding to various documents. For example, in cases where the user seeks more information or expresses dissatisfaction with a recommendation, the conversational interface can respond with detailed information drawn from the context documents or retrieved job listings. This capability provides technical improvements that enrich the user experience and also enhances accuracy of each of the processors 130, 140, 150 and 160, contributing to more accurate future recommendations. In an aspect, the object retrieval action processor 160 can return job listings associated with one or more tokens that match or correspond to one or more tokens of a query as discussed herein. In an aspect, the object retrieval action processor 160 receives context documents (e.g., job descriptions), and then classifies the context documents and creates questions for search indexing. For example, the questions can be stored in the system memory 162 (e.g., a specialized knowledge database). For example, the object retrieval action processor 160 retrieves information from the specialized knowledge database and provides the retrieved information to the matchmaking model processor 140.

The system memory 162 can store data associated with the system 100. The system memory 162 can include one or more hardware memory devices to store binary data, digital data, or the like. The system memory 162 can include one or more electrical components, electronic components, programmable electronic components, reprogrammable electronic components, integrated circuits, semiconductor devices, flip flops, arithmetic units, or the like. The system memory 162 can include at least one of a non-volatile memory device, a solid-state memory device, a flash memory device, or a NAND memory device. The system memory 162 can include one or more addressable memory regions disposed on one or more physical memory arrays. A physical memory array can include a NAND gate array disposed on, for example, at least one of a particular semiconductor device, integrated circuit device, and printed circuit board device.

The client system 103 can include a computing system associated with a database system. For example, the client system 103 can correspond to a cloud system, a server, a distributed remote system, or any combination thereof. For example, the client system 103 can include an operating system to execute a virtual environment. The operating system can include hardware control instructions and program execution instructions. The operating system can include a high-level operating system, a server operating system, an embedded operating system, or a boot loader. The client system 103 can include a token processor 170, a user interface 172, and an interface controller 174.

The token processor 170 can generate or provide a token associated with a user of the user interface 172 at the client system 103. For example, the token processor 170 can provide a token associated with a given user to the service provider system 102. For example, the service provider system 102 or the orchestration agent processor 120 can obtain or filter data corresponding to context based on the token. For example, the token processor 170 can indicate a given subset of data that is restricted or not restricted according to the user associated with the token or the token itself. For example, the filtered data can be filtered chat history or filtered documents as discussed herein, but is not limited thereto. In an aspect, the token associated with a user of the user interface 172 can correspond to a cryptographic token that is a unique identifier of the user or a device associated with the user. The cryptographic token can have a structure distinct from one or more tokens associated with a natural language processor as discussed herein.

The user interface 172 can include one or more devices to receive input from a user or to provide output to a user. For example, the user interface 172 can correspond to a display device to provide visual output to a user and one or more or user input devices to receive input from a user. For example, the input devices can include a keyboard, mouse or touch-sensitive panel of the display device, but are not limited thereto. The display device can display at least one or more presentations as discussed herein, and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The display device can be housed at least partially within the client system 103.

The interface controller 174 can link the client system 103 with one or more of the network 101 and the service provider system 102, by one or more communication interfaces. A communication interface can include, for example, an application programming interface (“API”) compatible with a particular component of the service provider system 102, or the client system 103. The communication interface can provide a particular communication protocol compatible with a particular component of the service provider system 102 and a particular component of the client system 103. The interface controller 174 can be compatible with particular content objects and can be compatible with particular content delivery systems corresponding to particular content objects, structures of data, types of data, or any combination thereof. For example, the interface controller 174 can be compatible with transmission of text data or binary data structured according to one or more metrics or data of the service provider system 102.

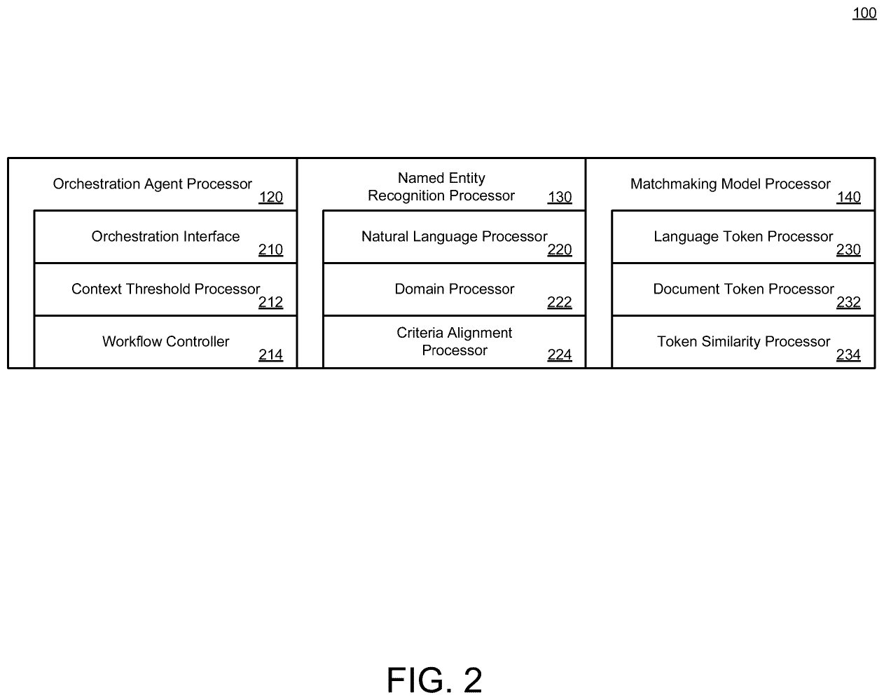

FIG. 2 depicts an example computer execution architecture, according to this disclosure. As illustrated by way of example in FIG. 2, a computer execution architecture 200 can be one or more instructions stored at the system memory 162 to cause one or more components of the system 100, the service provider system 102, the client system 103, or any combination thereof, but is not limited thereto. For example, the computer execution architecture 200 can include computational hardware or software integrated with the orchestration agent processor 120, the named entity recognition processor 130, and the matchmaking model processor 140, as illustrated in FIG. 2 by way of nonlimiting example. The orchestration agent processor 120 can include an orchestration interface 210, a context threshold processor 212, and a workflow controller 214. The named entity recognition processor 130 can include a natural language processor 220, a domain processor 222, and a criteria alignment processor 224. The matchmaking model processor 140 can include a language token processor 230, a document token processor 232, and a token similarity processor 234.

The orchestration interface 210 can include one or more communication channels coupled with one or more of the named entity recognition processor 130, the matchmaking model processor 140, the generative artificial intelligence processor 150, and the object retrieval action processor 160. For example, the orchestration interface 210 can transmit and receive bidirectional communication with one or more of the named entity recognition processor 130, the matchmaking model processor 140, the generative artificial intelligence processor 150, and the object retrieval action processor 160, or any component thereof. For example, the orchestration interface 210 can include one or more hardware communication traces or software APIs to interconnect with one or more of the components discussed above, but is not limited thereto.

The context threshold processor 212 can store or obtain one or more context thresholds indicative of sufficient context as discussed herein, and can determine whether a query satisfies a given threshold that indicates sufficient context. For example, the context threshold processor 212 can store a plurality of thresholds each associated with a distinct domain. In an aspect, different domains may require or benefit from differing levels of context to provide accurate responses, and increasing a threshold for satisfying sufficient context can increase computational resources or energy required as to the context threshold processor 212. Thus, the context threshold processor 212 can provide domain-specific context to optimize resource allocation and maintain high accuracy. For example, a query can be associated with a human resources job domain, which may require a high level of context to ensure that job recommendations align with the requirements. For example, a query can be associated with a general labor job domain, which may operate accurately with a low level of context because of the less specialized nature of the job roles. A level of context as discussed herein can correspond to a context threshold that indicates a given amount of additional context as discussed herein.

The workflow controller 214 can receive output of one or more components of the service provider system 102 and can provide instructions to the one or more components of the service provider system 102 to execute a workflow, including but not limited to the example workflow of FIG. 3. For example, the workflow controller 214 can execute one or more instructions from the orchestration agent processor 120 to make various determinations, decisions, comparisons, or any combination thereof as discussed herein, but is not limited thereto.

The natural language processor 220 can determine one or more properties of an input that correspond to a natural language. For example, a natural language as discussed herein can correspond to a human language (e.g., English, Spanish) but is not limited thereto. A natural language can have a semantic structure in which individual words, collections of words (e.g., phrases), or relative positions of words (e.g., word order) can indicate semantic meaning. The natural language processor 220 can receive input in the natural language (e.g., an English-language text string) and can output a data structure including one or more tokens indicative of the semantic meaning of portion of the string. For example, the natural language processor 220 can tokenize a query or a document to identify one or more named entities in the query or the document, and one or more semantic relationships between portions of the input (e.g., adjectives, verb modifiers, etc.). The domain processor 222 can identify at least one domain associated with a query or a document. For example, the domain processor 222 can identify one or more token in a query or a document, and can determine that the query or the document is associated with a given domain based on the presence of one or more words, tokens, phrases, or any combination thereof in the query or the document.

The criteria alignment processor 224 can determine whether a query has sufficient context with respect to a domain, or on a domain-agnostic basis, based on one or more alignment thresholds. In an aspect, the criteria alignment processor 224 can select an alignment threshold that is associated with a given domain. For example, an alignment threshold having a value of 20% can be associated with or suitable for general job searches, and an alignment threshold having a value of 80% can be associated with or suitable for highly skilled roles. For example, in the context of job recommendations, the criteria alignment processor 224 can determine that a query has sufficient context if a specified percentage of terms are associated with job-related entities. For example, a query containing multiple job titles or specific skill requirements can satisfy a higher alignment threshold. A default or domain-agnostic alignment threshold can be associated with or applied to a query whose domain is unknown or cannot be determined. Thus, the criteria alignment processor 224 can provide a technical improvement to support contextual understanding and augmentation across a broad variety of domains that have varying complexities in search traversal or database retrieval.

The language token processor 230 can determine one or more semantic properties associated with a query, based on the tokens of the query. For example, the language token processor 230 can cause the natural language processor 220 to generate one or more tokens for a query in response to receiving input from a user device including a query. For example, the language token processor 230 can cause the natural language processor 220 to generate the one or more tokens in real-time or substantially real-time (e.g., in less than 100 ms), for each query received. The language token processor 230 can augment one or more of the tokens of the query with one or more additional predetermined tokens that are associated with the type of token or tokenized word or phrase, to expand the semantic meaning of the token. For example, the language token processor 230 can augment a token for a verb or noun with tokens indicating synonyms of that verb or noun. For example, the language token processor 230 can augment a token for a named entity with tokens describing properties or associations of the named entity. The language token processor 230 can augment one or more portions of text of the query with one or more additional predetermined tokens that are associated with the type of token or tokenized word or phrase, to expand the semantic meaning of the token. For example, the language token processor 230 can augment a word or phrase with tokens indicating related or alternative phrases. For example, the language token processor 230 can augment text of “Boston” with text describing “city” or “state” as disambiguations.

The document token processor 232 can determine one or more semantic properties associated with a document, based on the tokens of the document. For example, the document token processor 232 can cause the natural language processor 220 to generate one or more tokens for a document in response to receiving a document at a database. For example, the document token processor 232 can cause the natural language processor 220 to generate the one or more tokens in a batch process that executes periodically on a database including documents. The document token processor 232 can augment one or more of the tokens of the document with one or more additional predetermined tokens that are associated with the type of token or tokenized word or phrase, to expand the semantic meaning of the token. For example, the document token processor 232 can augment a token for a verb or noun with tokens indicating synonyms of that verb or noun. For example, the document token processor 232 can augment a token for a named entity with tokens describing properties or associations of the named entity. The document token processor 232 can augment one or more portions of text of the query with one or more additional predetermined tokens that are associated with the type of token or tokenized word or phrase, to expand the semantic meaning of the token. For example, the document token processor 232 can augment a word or phrase with tokens indicating related or alternative phrases. For example, the document token processor 232 can augment text of “Boston” with text describing “city” or “state” as disambiguations.

The token similarity processor 234 can determine a match or correspondence between a query and one or more documents based at least on comparisons of one or more tokens or augmented tokens of a query with one or more tokens or augmented tokens of one or more documents. For example, the token similarity processor 234 can traverse each word, token, augmented token, phrase, or any combination thereof, of a query, to identify a match with any word, token, augmented token, phrase, or any combination thereof, of one or more documents. The token similarity processor 234 is not limited to matching objects of a same type. For example, the token similarity processor 234 can return a match between a token and an augmented token, a word string and a token, or any other permutation of the above-noted examples, but is not limited thereto. Thus, the token similarity processor 234 can provide a technical improvement to return documents that are similar to a query based on a diverse set of matching criteria that can be tailored to a given domain.

FIG. 3 depicts an example computer execution workflow, according to this disclosure. As illustrated by way of example in FIG. 3, a computer execution workflow 300 can be one or more instructions stored at the system memory 162 to cause one or more components of the system 100, the service provider system 102, the client system 103, or any combination thereof, but is not limited thereto.

In an example workflow a computing device associated with a user transmits a conversation session token (e.g., a cryptographic token as discussed herein) and a user input including a query. For example, the query can include text for “I'm John and looking for an entry-level position that requires no specific skills.” The query can indicate a request for recommending entry-level positions (or document objects) and include criteria for selecting the document objects, such as having “no specific skills.” The orchestration agent processor 120 (or “Agent 120” as illustrated in FIG. 3) can map one or more entities and provide the query to the named entity recognition processor 130. For example, mapping entities can correspond to instructing the named entity recognition processor 130 via the workflow controller 214 to tokenize the query to identify named entities. For example, the named entity recognition processor 130 can identify named entities including a “name” named entity having the value “John,” “skills” named entity having the value “no specific,” an “instruction” named entity having the value “looking for,” and “interests” named entity having the value “entry-level position.”

The Agent 120 can receive the output of the named entity recognition processor 130 and can determine whether sufficient context exists for the query. If sufficient context does not exist, the workflow controller 214 can instruct the generative artificial intelligence (AI) processor 150 to conduct a chatbot interaction via the interface controller 112 to obtain user input from which additional context can be derived or extracted by the Agent 120.

If the Agent 120 identifies sufficient context, the Agent 120 can instruct the matchmaking model processor 140 to identify documents that match the query according to the similarity determinations as discussed herein. The matchmaking model processor 140 can obtain, via the object retrieval action processor 160, one or more first data objects. The first data objects can point to relevant document objects based on the user's query. The data objects can use one or more data structures to represent information relevant to the user's query. For example, a first data structure of the data object can be configured in a format (e.g., text-based format) that allows searching based on the criteria provided by the user. The first data structure can include elements such as keywords, summaries, or indexes extracted from the document. The first structure can allow the data to be searchable according to one or more criteria specified. In addition to the searchable format, a data object can be configured to include a second data structure that is compatible with the generative AI processor 150 (e.g., the large language model). The second data structure can include machine-readable instructions, such as embeddings or vectors. In some embodiments, the matchmaking model processor 140 can identify and/or retrieve, via the object retrieval action processor 160, one or more second data objects (e.g., metadata, content summaries, semantic features, etc.) in response to processing the elements of the first data object (e.g., keywords, concepts, themes, etc.). The second data object can provide a machine-readable representation of the first data object, for example, for the processing capabilities of the generative AI processor 150. The second data object can include numerical vectors that can identify the relationship between words or concepts within the document. The second data object can represent common data extracted from the first data object, for example, using a text-based format for the first data structure and a numerical vector format (or a machine-readable format) for the second data structure. The numerical vectors, or embeddings, can capture the semantic relationships between words and concepts within the document. The generative AI processor 150 can use these embeddings or vectors to understand the context of the document.

If the matchmaking model processor 140 fails to identify matches or that output of the matchmaking model processor 140 indicates a lack of sufficient context to obtain any documents (or job listings), the workflow controller 214 can instruct the generative AI processor 150 to conduct a chatbot interaction via the interface controller 112 to obtain user input from which additional context can be derived or extracted by the Agent 120.

The matchmaking model processor 140 can return one or more documents matching the query and can provide those results to the Agent 120. The Agent 120 can provide the results to the generative AI processor 150 to generate a text response in natural language that includes the results and includes generated text indicative of reasoning (e.g., a description of similarity analyses that returned the results) for returning the results. In some embodiments, the generative AI processor 150 can process the input (including queries, first data objects, and/or second data objects) to generate a reply, for example, delivering job recommendations that align with the user's needs and preferences. The generative AI processor 150 can generate one or more summary objects for each retrieved document object. The summary object can include object text that describes the content of the document. For example, based on identifying the key skills and requirements in the job descriptions, the generative AI processor 150 can deliver job recommendations directed to the user's needs. These recommendations or summaries can provide a description of the content (e.g., object text) and indicate qualifications, responsibilities, and other relevant details most relevant to the user's needs, as mentioned in their query. In some embodiments, the generative AI processor 150 can modify the original document data to incorporate generated summaries or additional information. This modification process can incorporate elements such as job descriptions, required skills, or other relevant details into the original document data.

The Agent 120 can leverage feedback from the user to refine the search parameters and improve the quality of subsequent recommendations. For example, a response can include text of “Here are the most suited entry-level positions for you, John. <list of job openings> <reasoning text>.” In the case of a job search, the generated text can be further personalized to generate summaries indicating the applicant's most relevant skills and experiences for each job opening. If additional context is needed after returning the results, the workflow controller 214 can instruct the generative artificial intelligence processor 150 to conduct a chatbot interaction via the interface controller 112 to obtain user input from which additional context can be derived or extracted by the Agent 120. For example, an interaction to obtain additional context can include a text query of “What kind of job roles are you interested in, John?” In this manner, the generative artificial intelligence processor 150 can be configured to actively engage users through an investigative AI approach.

In some embodiments, the generative AI processor 150 can process the user's query to understand or determine the natural language corresponding to the context of the query and modify retrieved documents to match that natural language, for example, the user's natural language style. For instance, if a user employs technical jargon, the generative AI processor 150 can be configured to present job descriptions in a similarly technical manner. The generative AI processor 150 can determine the natural language of the query and apply it to modify document content accordingly. By processing a user's chat history and a series of queries, the generative artificial intelligence processor 150 can be configured to dynamically adapt its dialogue system and improve its understanding of the preferred natural language, leading to improved search results. For example, if a user consistently uses informal language and abbreviations, the generative AI processor 150 can adjust the style of job recommendations to be more conversational. In some embodiments, the generative AI processor 150 can use the LLM to process user queries and determine the appropriate natural language style. The generative AI processor 150 can modify document content to match the identified language style. For example, by processing a series of queries, the generative AI processor 150 can refine its understanding of user preferences over time.

The workflow can be conducted iteratively at least as illustrated in FIG. 3, including multiple pathways for the Agent 120 to obtain, via the workflow controller 214, additional context from the user or from a data storage 164 including chat history and context. For example, the chat history and context can be associated with (e.g., via one or more tags or by identification of tokens associated with named entities) one or more users or domains. The Agent 120 can obtain additional context from the chat history and context data at multiple points in the workflow 300, to provide technical solutions to enrich content and a technical improvement to increase accuracy of document search results while reducing use of computational resources by reducing the number of queries required to be generated and transmitted to a user device. Reducing the amount of computational resources consumed by generative AI processors 150 can be significant in terms of processing time and power consumption, due to the large number of computations that can be required to create generative output.

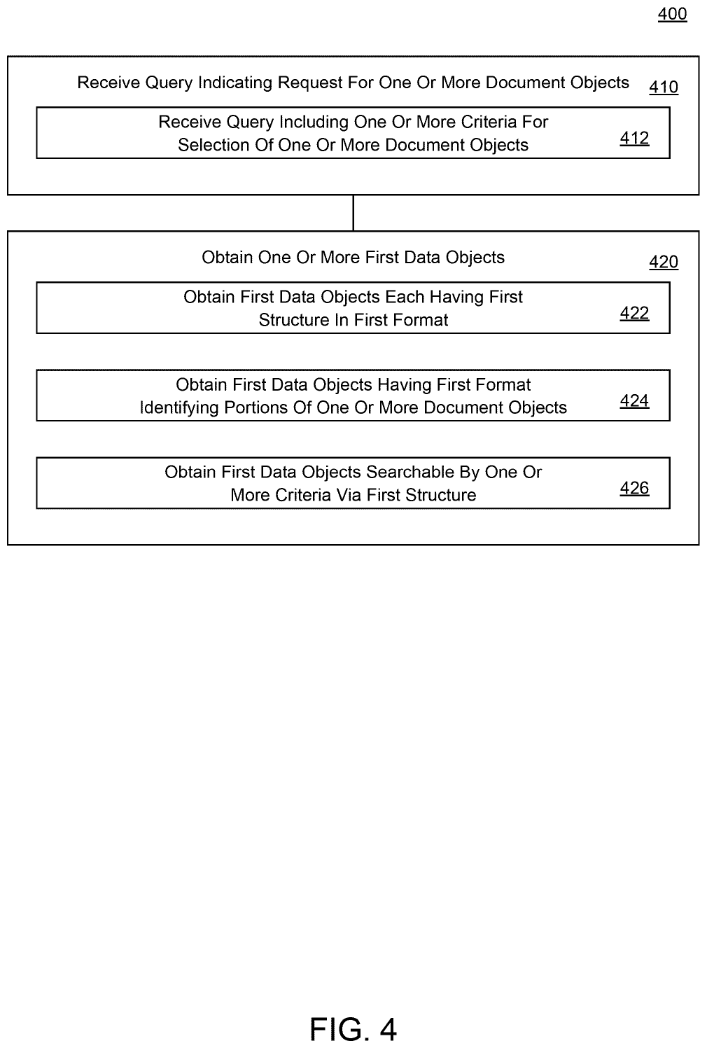

FIG. 4 depicts an example method of large language model architecture for delivering digital content, according to this disclosure. At least one of the system 100, the service provider system 102, the client system 103, or any combination thereof, or any component thereof, can perform method 400. At 410, the method 400 can receive a query indicating a request for one or more document objects. At 412, the method 400 can receive the query including one or more criteria for selection of the one or more document objects. At 420, the method 400 can obtain one or more first data objects. At 422, the method 400 can obtain the first data objects each having a first structure in a first format. At 424, the method 400 can obtain the first data objects having a first format identifying portions of the one or more document objects. At 426, the method 400 can obtain the first data objects searchable according to the one or more criteria via the first structure.

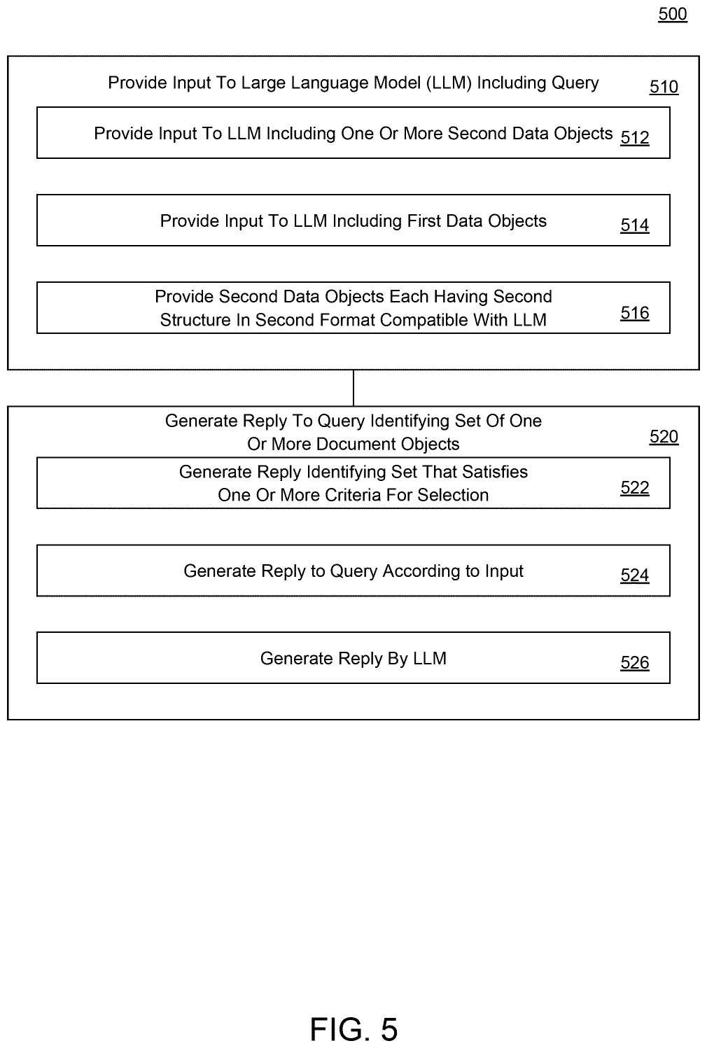

FIG. 5 depicts an example method of large language model architecture for delivering digital content, according to this disclosure. At least one of the system 100, the service provider system 102, the client system 103, or any combination thereof, or any component thereof, can perform method 500. At 510, the method 500 can provide input to a large language model (LLM) including the query. At 512, the method 500 can provide input to the LLM including one or more second data objects. At 514, the method 500 can provide input to the LLM including the first data objects. At 516, the method 500 can provide the second data objects each having a second structure in a second format compatible with the LLM. In an aspect, the method can include where the second structure corresponds to at least one of an embedding compatible with the LLM or a vector compatible with the LLM. In an aspect, the method can include generating the second data objects based on the first data objects to indicate common data according to a first format of the first structure and a second format of the second structure. In an aspect, the method can include where the first format corresponds to a text-based format. In an aspect, the method can include where the second format corresponds to a machine-readable format.

In an aspect, the method can include generating, by the LLM according to a second input including the one or more document objects and one or more third data objects, one or more summary objects, each respectively including object text descriptive of each of the document objects. In an aspect, the method can include where the third data objects have the second structures in the machine-readable format that is compatible with the LLM. In an aspect, the method can include where the object text is descriptive of at least one of a job description or one or more skills corresponding to the job description. In an aspect, the method can include modifying the one or more first data objects to include the object text for respective instances of the one or more document objects.

At 520, the method 500 can generate a reply to the query identifying a set of the one or more document objects. At 522, the method 500 can generate the reply identifying the set that satisfies the one or more criteria for selection. At 524, the method 500 can generate the reply according to the input. At 526, the method 500 can generate the reply by the LLM. In an aspect, the method can include determining, by the LLM according to the input, a natural language corresponding to content of the query. The method can include modifying, by the LLM according to the input, at least one portion of at least one of the documents to the natural language. In an aspect, the method can include determining the natural language according to a plurality of queries, where the plurality of queries can correspond to a chat history of a plurality of inputs for the LLM.

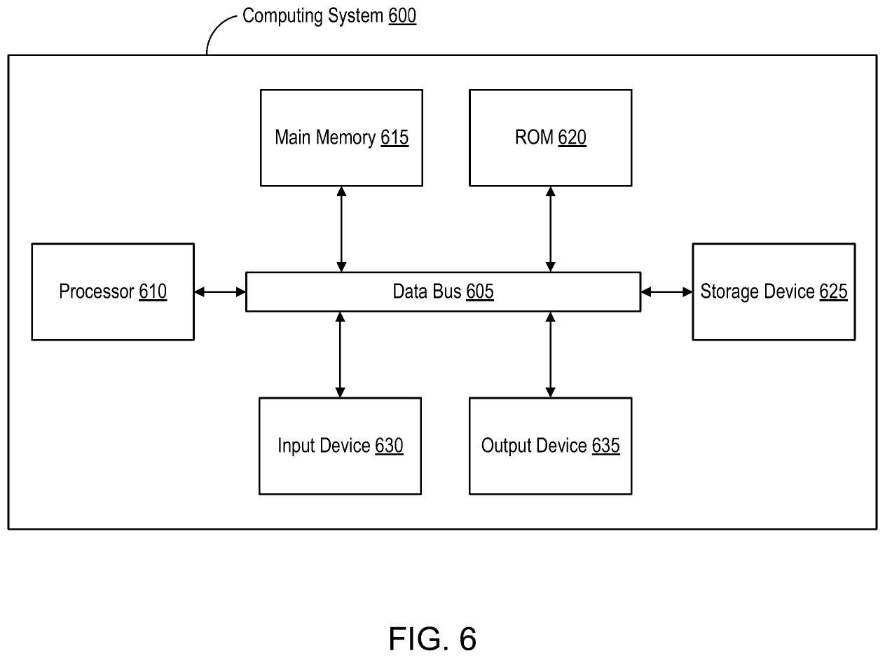

FIG. 6 depicts a block diagram of a computing system 600 for implementing the embodiments of the technical solutions discussed herein, in accordance with various aspects. FIG. 6 illustrates a block diagram of an example computing system 600, which can also be referred to as the computer system 600. Computing system 600 can be used to implement elements of the systems and methods described and illustrated herein. Computing system 600 can be included in and run any device (e.g., a server, a computer, a cloud computing environment or a data processing system).

Computing system 600 can include at least one bus data bus 605 or other communication device, structure or component for communicating information or data. Computing system 600 can include at least one processor 610 or processing circuit coupled to the data bus 605 for executing instructions or processing data or information. Computing system 600 can include one or more processors 610 or processing circuits coupled to the data bus 605 for exchanging or processing data or information along with other computing systems 600. Computing system 600 can include one or more main memories 615, such as a random access memory (RAM), dynamic RAM (DRAM), cache memory or other dynamic storage device, which can be coupled to the data bus 605 for storing information, data and instructions to be executed by the processor(s) 610. Main memory 615 can be used for storing information (e.g., data, computer code, commands or instructions) during execution of instructions by the processor(s) 610.

Computing system 600 can include one or more read only memories (ROMs) 620 or other static storage device 625 coupled to the bus 605 for storing static information and instructions for the processor(s) 610. Storage devices 625 can include any storage device, such as a solid state device, magnetic disk or optical disk, which can be coupled to the data bus 605 to persistently store information and instructions.

Computing system 600 can be coupled via the data bus 605 to one or more output devices 635, such as speakers or displays (e.g., liquid crystal display or active matrix display) for displaying or providing information to a user. Input devices 630, such as keyboards, touch screens or voice interfaces, can be coupled to the data bus 605 for communicating information and commands to the processor(s) 610. Input device 630 can include, for example, a touch screen display (e.g., output device 635). Input device 630 can include a cursor control, such as a mouse, a trackball, or cursor direction keys, for communicating direction information and command selections to the processor(s) 610 for controlling cursor movement on a display.

The processes, systems and methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors 610 in a multi-processing arrangement can also be employed to execute the instructions contained in main memory 615. Hard-wired circuitry can be used in place of or in combination with software instructions together with the systems and methods described herein. Systems and methods described herein are not limited to any specific combination of hardware circuitry and software.

Although an example computing system has been described in FIG. 6, the subject matter including the operations described in this specification can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors, coupled with memory, to:
receive a query indicating a request for one or more document objects and including one or more criteria for selection of the one or more document objects;
obtain one or more first data objects each having a first structure in a first format identifying portions of the one or more document objects, the first data objects searchable according to the one or more criteria via the first structure;
provide input to a large language model (LLM) including the query, the first data objects, and one or more second data objects, the second data objects each having a second structure in a second format that is compatible with the LLM; and
generate, by the LLM according to the input, a reply to the query identifying a set of the one or more document objects that satisfies the one or more criteria for selection.

2. The system of claim 1, comprising the one or more processors to:
generate, by the LLM according to a second input including the one or more document objects and one or more third data objects, one or more summary objects each respectively including object text descriptive of each of the document objects.

3. The system of claim 2, comprising the one or more processors to:
modify the one or more first data objects to include the object text for respective instances of the one or more document objects,
wherein the object text is descriptive of at least one of a job description, or one or more skills corresponding to the job description.

4. The system of claim 2, wherein the third data objects each have the second structure in the machine-readable format that is compatible with the LLM.

5. The system of claim 1, comprising the one or more processors to:
generate the second data objects based on the first data objects to indicate common data according to a first format of the first structure and a second format of the second structure.

6. The system of claim 5, wherein the first format corresponds to a text-based format, and the second format corresponds to a machine-readable format.

7. The system of claim 1, wherein the second structure corresponds to at least one of an embedding compatible with the LLM or a vector compatible with the LLM.

8. The system of claim 1, comprising the one or more processors to:
determine, by the LLM according to the input, a natural language corresponding to content of the query; and
modify, by the LLM according to the input, at least one portion of at least one of the documents to the natural language.

9. The system of claim 1, comprising the one or more processors to:
determine the natural language according to a plurality of queries including the query, the plurality of queries corresponding to a chat history of a plurality of inputs for the LLM.

10. A method, comprising:
receiving a query indicating a request for one or more document objects and including one or more criteria for selection of the one or more document objects;
obtaining one or more first data objects each having a first structure in a first format identifying portions of the one or more document objects, the first data objects searchable according to the one or more criteria via the first structure;
providing input to a large language model (LLM) including the query, the first data objects, and one or more second data objects, the second data objects each having a second structure in a second format that is compatible with the LLM; and
generating, by the LLM according to the input, a reply to the query identifying a set of the one or more document objects that satisfies the one or more criteria for selection.

11. The method of claim 10, further comprising:
generating, by the LLM according to a second input including the one or more document objects and one or more third data objects, one or more summary objects each respectively including object text descriptive of each of the document objects.

12. The method of claim 11, further comprising:
modifying the one or more first data objects to include the object text for respective instances of the one or more document objects,
wherein the object text is descriptive of at least one of a job description, or one or more skills corresponding to the job description.

13. The method of claim 11, wherein the third data objects each have the second structure in the machine-readable format that is compatible with the LLM.

14. The method of claim 10, further comprising:
generating the second data objects based on the first data objects to indicate common data according to a first format of the first structure and a second format of the second structure.

15. The method of claim 14, wherein the first format corresponds to a text-based format, and the second format corresponds to a machine-readable format.

16. The method of claim 10, wherein the second structure corresponds to at least one of an embedding compatible with the LLM or a vector compatible with the LLM.

17. The method of claim 10, further comprising:
determining, by the LLM according to the input, a natural language corresponding to content of the query; and
modifying, by the LLM according to the input, at least one portion of at least one of the documents to the natural language.

18. The method of claim 10, further comprising:
determining the natural language according to a plurality of queries including the query, the plurality of queries corresponding to a chat history of a plurality of inputs for the LLM.

19. A non-transitory computer readable medium including one or more instructions stored thereon and executable by a processor to:
receive, by a processor, a query indicating a request for one or more document objects and including one or more criteria for selection of the one or more document objects;
obtain, by the processor, one or more first data objects each having a first structure in a first format identifying portions of the one or more document objects, the first data objects searchable according to the one or more criteria via the first structure;
provide, by the processor, input to a large language model (LLM) including the query, the first data objects, and one or more second data objects, the second data objects each having a second structure in a second format that is compatible with the LLM; and
generate, by the processor executing the LLM according to the input, a reply to the query identifying a set of the one or more document objects that satisfies the one or more criteria for selection.

20. The non-transitory computer readable medium of claim 19, further including one or more instructions executable by the processor to:
generate, by the processor executing the LLM according to a second input including the one or more document objects and one or more third data objects, one or more summary objects each respectively including object text descriptive of each of the document objects; and
modify, by the processor, the one or more first data objects to include the object text for respective instances of the one or more document objects,
wherein the object text is descriptive of at least one of a job description, or one or more skills corresponding to the job description.
